(19) United States
(12) Patent Application Publication
(10) Pub. No.: US 2026/0266210 A1
(43) Pub. Date: Sep. 10, 2026

(54) ADAPTIVE CONTROL OF A WATER PUMP IN A MARINE PROPULSION SYSTEM

(71) Applicant: VISION MARINE TECHNOLOGIES, BOISBRIAND (CA)

(72) Inventor: XAVIER MONTAGNE, LAVAL (CA)

(21) Appl. No.: 19/074,527

(22) Filed: Mar. 10, 2025

(51) Int. Cl. F01P 7/16; F01P 11/18

(52) U.S. Cl. CPC F01P 7/164; F01P 11/18; F01P 2031/20; F01P 2050/12

(57) ABSTRACT

According to embodiments of the present disclosure, various methods, apparatuses, and computer program products for adaptive control of a water pump in a marine propulsion system are described herein. In a particular embodiment, a method of adaptive control of a water pump in a marine propulsion system includes a pump controller receiving a current measurement of the water pump and comparing the received current measurement to a reference current profile stored in a non-volatile memory of the pump controller. The method also includes the pump controller determining, based on a comparison of the received current measurement to the reference current profile, whether the water pump is operating in a reduced-flow condition or a no-flow condition. The method also includes the pump controller adjusting, based on a determination of whether the water pump is operating in a reduced-flow condition or a non-flow condition, a voltage supplied to the water pump.

### FIELD OF THE TECHNOLOGY

The present disclosure relates to methods, apparatuses, and computer program products for adaptive control of a water pump in a marine propulsion system.

### BACKGROUND

Traditional marine vessels have predominantly relied on internal combustion engines (ICE) for propulsion, which typically involve complex mechanical systems and fuel-based power sources. These systems often require extensive maintenance and are subject to environmental regulations due to emissions. In recent years, there has been a shift towards integrating electric propulsion systems in marine vessels, driven by the need for cleaner and more efficient alternatives. Early electric marine vessels often utilized low-voltage battery systems and direct current (DC) motors, which limited their power output and range, making them suitable primarily for small boats or short-distance travel.

As technology advanced, the introduction of high voltage (HV) battery systems allowed for greater power capacity and efficiency in electric marine vessels. These systems enabled the use of more powerful electric motors, which could support larger vessels and longer travel distances. However, integrating HV systems into marine vessels presented challenges, such as ensuring safe and efficient power distribution and managing the complex interactions between various powertrain components. Traditional approaches often involved custom wiring solutions and proprietary communication systems, which could complicate maintenance and scalability.

### SUMMARY

According to embodiments of the present disclosure, various methods, apparatuses, and computer program products for adaptive control of a water pump in a marine propulsion system are described herein. In a particular embodiment, a method of adaptive control of a water pump in a marine propulsion system includes a pump controller receiving a current measurement of the water pump and comparing the received current measurement to a reference current profile stored in a non-volatile memory of the pump controller. The method also includes the pump controller determining, based on a comparison of the received current measurement to the reference current profile, whether the water pump is operating in a reduced-flow condition or a no-flow condition. The method also includes the pump controller adjusting, based on a determination of whether the water pump is operating in a reduced-flow condition or a non-flow condition, a voltage supplied to the water pump.

In a particular embodiment, an apparatus for adaptive control of a water pump in a marine propulsion system is disclosed. The apparatus includes a microcontroller configured to receive a measurement signal indicative of current drawn by the water pump and compare the measurement signal to a reference current profile stored in a memory. The microcontroller is also configured to determine, based on a comparison of the received current measurement signal to the reference current profile, whether the water pump is operating in a reduced-flow condition or no-flow condition and generate a control signal responsive to said determination of whether the water pump is operating in a reduced-flow condition or a non-flow condition. The apparatus also includes a sensor interface coupled to the microcontroller, the sensor interface configured to measure the current drawn by the water pump and provide the measurement signal to the microcontroller. In this embodiment, the apparatus also includes a driver stage configured to receive the control signal from the microcontroller and adjust a voltage applied to the water pump in accordance with the control signal. The apparatus also includes a communication interface configured to exchange data with an outboard power control unit (PCU).

These adaptive pump controller functions offer a novel approach to intelligent water pump management in marine propulsion systems. By continuously monitoring current draw and automatically distinguishing between reduced-flow and no-flow conditions, the controller tailors corrective actions precisely to the degree of flow impairment. This targeted response reduces unnecessary pump shutdowns while still preserving the impeller's integrity in severe conditions. Moreover, the adaptive control of pump voltage and speed in response to real-time data enables higher energy efficiency and avoids wasteful operation. Detailed logging of events and CAN-based communication further enhance diagnosability, allowing for rapid intervention and performance optimization. Collectively, these features safeguard the impeller from premature wear, minimize downtime, and extend the overall service life of the water pump.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a block diagram of an example electric marine vessel in accordance with at least one embodiment of the present disclosure.

FIG. 1B sets forth a block diagram of an example marine propulsion system of an electric marine vessel in accordance with at least one embodiment of the present disclosure.

FIG. 1C sets forth a block diagram of an example high voltage battery of an electric marine vessel in accordance with at least one embodiment of the present disclosure.

FIG. 1D sets forth a block diagram of an example power distribution unit in accordance with at least one embodiment of the present disclosure.

FIG. 1E sets forth a block diagram of an example vessel control unit of an electric marine vessel in accordance with at least one embodiment of the present disclosure.

FIG. 2A sets forth a block diagram of an example security management module for authenticating powertrain components of an electric marine vessel in accordance with at least one embodiment of the present disclosure.

FIG. 2B sets forth another example of the security management module of FIG. 2A.

FIG. 3 sets forth a block diagram of an example distributed control system architecture for an electric marine vessel in accordance with at least one embodiment of the present disclosure.

FIG. 4 sets forth a flow chart of an example method of adaptive control of a water pump in a marine propulsion system in accordance with at least one embodiment of the present disclosure.

FIG. 5 sets forth a flow chart of another example method of adaptive control of a water pump in a marine propulsion system in accordance with at least one embodiment of the present disclosure.

FIG. 6 sets forth a flow chart of another example method of adaptive control of a water pump in a marine propulsion system in accordance with at least one embodiment of the present disclosure.

FIG. 7 sets forth a flow chart of another example method of adaptive control of a water pump in a marine propulsion system in accordance with at least one embodiment of the present disclosure.

FIG. 8 sets forth a flow chart of another example method of adaptive control of a water pump in a marine propulsion system in accordance with at least one embodiment of the present disclosure.

FIG. 9 sets forth a flow chart of another example method of adaptive control of a water pump in a marine propulsion system in accordance with at least one embodiment of the present disclosure.

FIG. 10 sets forth a flow chart of another example method of adaptive control of a water pump in a marine propulsion system in accordance with at least one embodiment of the present disclosure.

FIG. 11 sets forth a flow chart of another example method of adaptive control of a water pump in a marine propulsion system in accordance with at least one embodiment of the present disclosure.

FIG. 12 sets forth a flow chart of another example method of adaptive control of a water pump in a marine propulsion system in accordance with at least one embodiment of the present disclosure.

FIG. 13 sets forth a flow chart of another example method of adaptive control of a water pump in a marine propulsion system in accordance with at least one embodiment of the present disclosure.

### DETAILED DESCRIPTION

Advances in battery technology have paved the way for full-electric vehicles. Building on those advances, technology to enable full-electric watercraft has been widely adopted. However, the challenges of designing electric vehicles are different from the challenges of designing electric boats. The transformation of existing watercraft platforms to a full-electric platform also poses a different set of challenges. A particular challenge faced by electric watercraft is the weight and complexity of wire harnesses used to connect various powertrain components, and the scalability of the powertrain system.

The present invention relates to a distributed control system architecture that provides local controllers in each powertrain component that independently manage the operation of the powertrain component. After using an ignition signal to wake up the controller, all control signaling is carried out by control commands that are transmitted over the CAN bus. Based on these commands, the local controller independently operates the powertrain component. This distributed control system architecture reduces complexity by utilizing a CAN bus for control, thus eliminating the need for traditional wiring. The distributed control system architecture in accordance with the present disclosure enhances reliability by ensuring that each component operates independently while being coordinated by the VCU. The distributed control system architecture in accordance with the present disclosure improves safety with HVIL connections that provide a robust safety mechanism, preventing accidental operation and ensuring proper system integration. The distributed control system architecture in accordance with the present disclosure improves scalability in that the modular design allows easy integration of additional components or functionalities without significant redesign.

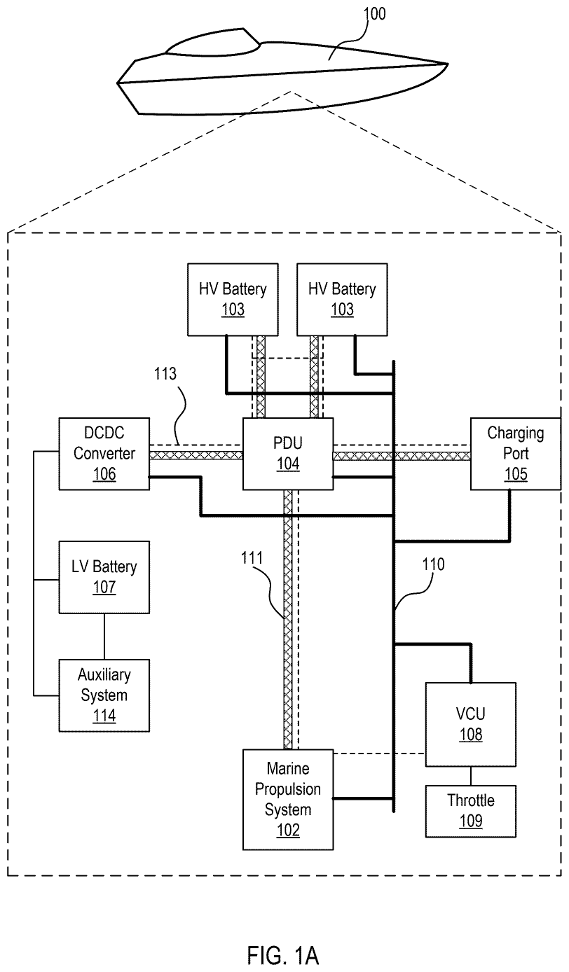

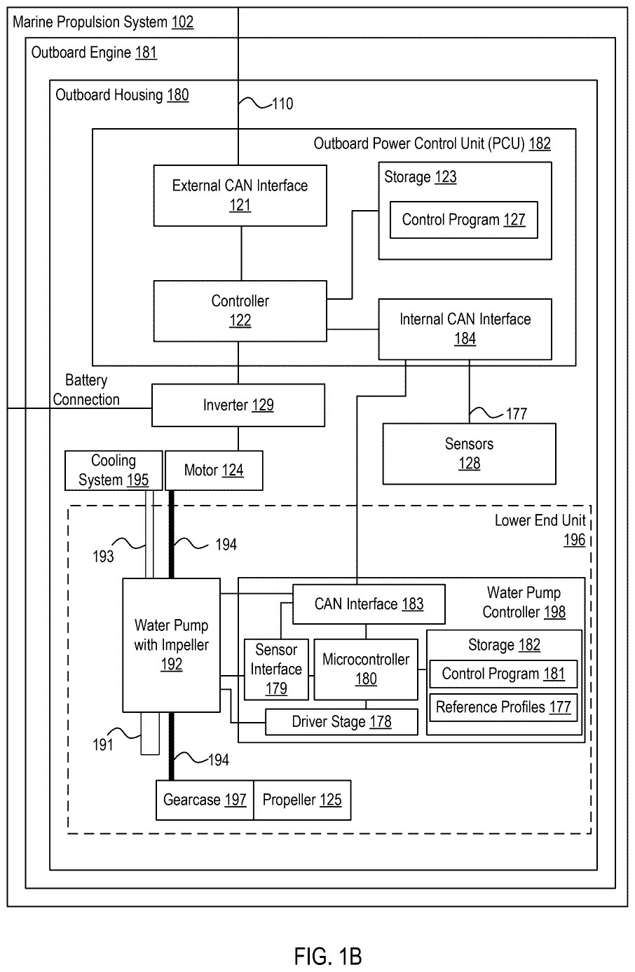

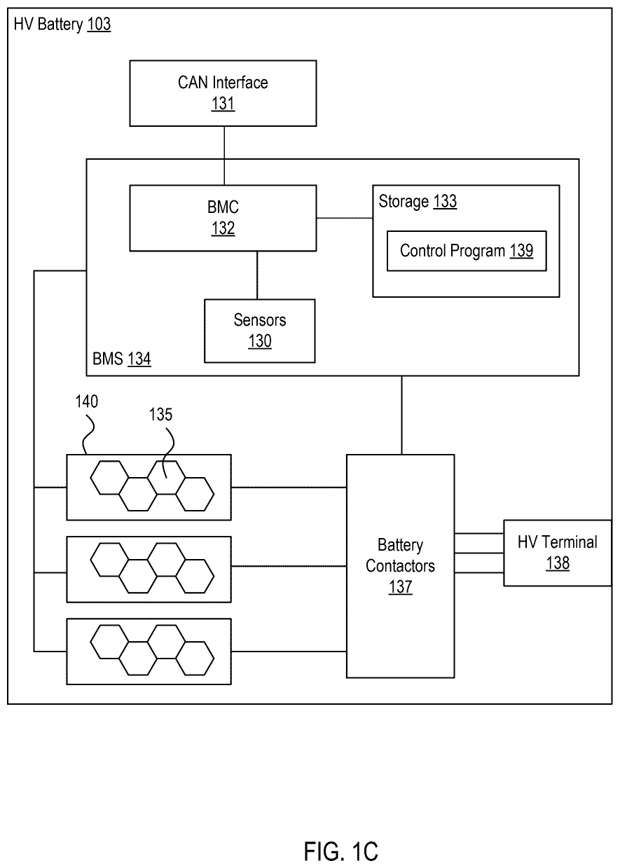

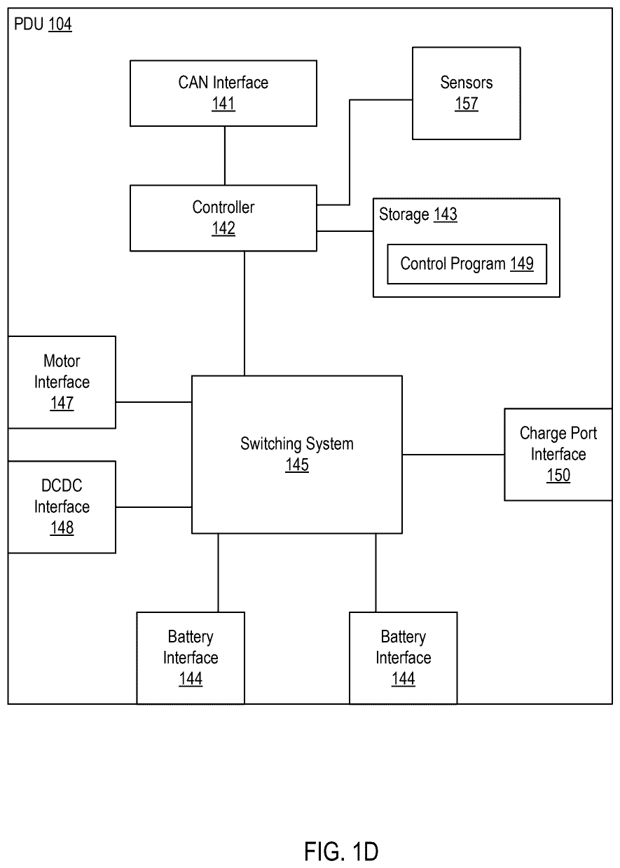

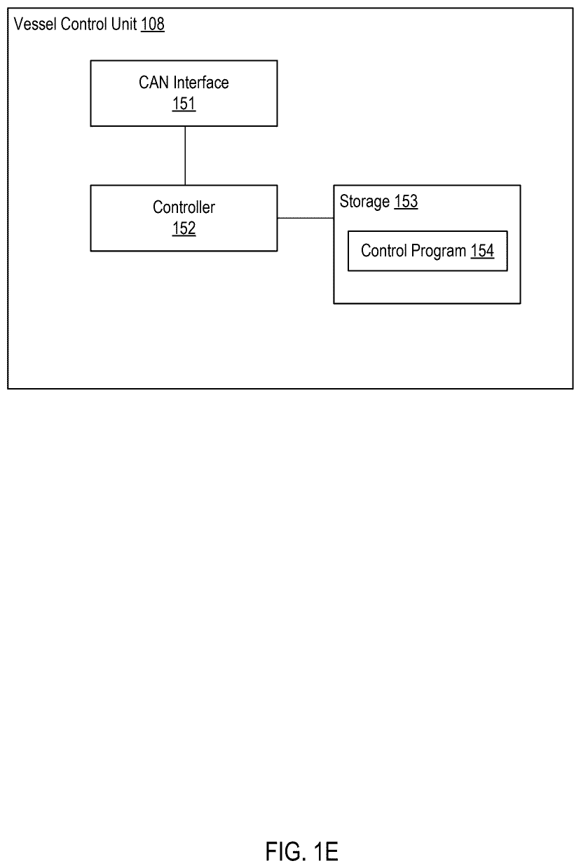

FIG. 1A sets forth an example electric vessel apparatus (hereinafter, “vessel”) 100 for authenticating powertrain components of an electric vessel by a battery management controller in accordance with the present disclosure. FIG. 1A is provided to emphasize the powertrain components of vessel 100. It will be appreciated that vessel 100 may include other components not shown or described herein. Vessel 100 may be any type of watercraft. In a particular example, vessel 100 includes a full-electric powertrain and thus may also referred to as an ‘electric boat.’ To that end, vessel 100 includes a marine propulsion system 102. The marine propulsion system is described in more detail below with reference to FIG. 1B. In a particular example, vessel 102 is a recreational electric boat and marine propulsion system 102 is a full-electric outboard engine powered by high voltage (e.g., 400V or more) batteries.

The marine propulsion system 102 is powered by one or more high voltage batteries 103.

In the example, of FIG. 1A, two high voltage batteries 103 are shown; however, it will be appreciated a vessel 100 in accordance with the present disclosure may include fewer or more high voltage batteries. High voltage batteries operate at voltages ranging from a few hundred to over 800 volts, depending on the design and application. Higher voltages allow for more efficient power transmission and reduced current flow, which helps minimize energy losses. Each high voltage battery 103 includes multiple modules, each containing several individual battery cells connected in series and parallel configurations to achieve the desired voltage and capacity. These cells may be arranged in a pack that optimizes space utilization and facilitates thermal management. Each high voltage battery 103 includes or is coupled to a battery management system (BMS). The BMS is responsible for monitoring and controlling various parameters such as voltage, current, temperature, and state of charge (SoC) of individual cells within the pack. The BMS helps optimize battery performance, protect against overcharging or over-discharging, and ensures safety. The BMS communicates with other vessel components about battery state, receives commands to change the battery state, and controls the opening and closing of the main contactors in the battery. The high voltage battery 103 is described in more detail below with reference to FIG. 1C.

The marine propulsion system 102 receives power from the high voltage battery 103 via a power distribution unit (PDU) 104. The PDU 104 receives high-voltage DC power from the high voltage batteries 103 and routes it to different subsystems and components within vessel 100, such as the electric marine propulsion system 102 and other subsystems such as a DCDC converter 106. The PDU 104 also couples the high voltage batteries 103 to a charging port 105 for charging the high voltage batteries 103. The PDU 104, as explained in more detail below with reference to FIG. 1D, includes a set of contactors that are controlled by logic or software in the PDU 104 to ensure safety when switching the flow of power among various vessel components.

The DCDC converter 106 provides voltage conversion capabilities to step down the high-voltage DC power to lower voltages required by an auxiliary system 114, such as the 12-volt electrical system used for lights, accessories, and onboard electronics. The DCDC converter 106 may be used to charge a lower voltage battery such as a 12-volt marine battery 107.

Vessel 100 further includes a vessel control unit (VCU) 108. Vessel control unit 108 serves as the central control unit responsible for managing and coordinating various functions and systems onboard the vessel 100. For example, the vessel control unit 108 can provide propulsion control, including regulating engine speed, torque, and direction to achieve desired propulsion performance and maneuverability in accordance with commands or signals received from the vessel's throttle control 109. The vessel control unit 108 can also manage the vessel's steering system. The vessel control unit 108 can also control startup/shut down routines, control charging/operation mode selection, control the opening and closing of contactors in the PDU 104, monitor the state of onboard systems, perform vessel diagnostics, and interface with an operator dashboard. To that end, the vessel control unit 108 may communicate with the other vessel powertrain components (e.g., the marine propulsion system 102, the high voltage battery 103, the PDU 104, the DCDC converter 106, and so one) via a control area network (CAN), referred to herein as a CAN bus 110. The vessel control unit 108 will be described in more detail below with reference to FIG. 1E.

The CAN bus 110 may be a two-wire serial bus that allows multiple components and devices within a vessel to communicate with each other without a host computer. The CAN bus 110 may use a message-based communication scheme where components and devices send and receive data in the form of messages. Each message includes a CAN identifier (CAN ID), data bytes, and control bits. The CAN bus 110 may employ a multi-master architecture, in that any device on the network can initiate a message transmission. This distributed architecture allows for efficient communication between vessel components without the need for a centralized controller. In a particular example, the CAN bus 110 may implement the NMEA2000 protocol, a standard set forth by the National Marine Electronics Association. NMEA2000 provides optimization and messaging for a marine environment.

Vessel 100 can also include a high voltage interlock loop (HVIL) system, which is a safety feature designed to ensure the safe operation and maintenance of the high-voltage components. HVIL is a dedicated circuit that ensures the high voltage connectors are well inserted in the equipment mating connector to ensure the safety of the high voltage connections. HVIL is used by the high voltage battery BMS and the vessel control unit 108 to confirm the integrity of these connections before applying high voltage energy to each high voltage device in the vessel.

For ease of reference, in FIG. 1A power interconnects 111 supplying high voltage power are shown in hash-filled lines, data interconnects for CAN bus 110 are shown in thick solid black lines, and HVIL interconnects 113 are shown in dashed lines.

For further explanation, FIG. 1B sets forth a block diagram of an example of the electric marine propulsion system 102 in accordance with at least one embodiment of the present disclosure. The example marine propulsion system 102 of FIG. 1B includes an outboard engine 181 having an outboard housing 180. Readers of skill in the art will realize that the marine propulsion system 102 may include additional outboard engines that are not pictured but are in accordance with embodiments of the present disclosure.

The outboard housing 180 houses an outboard power control unit (PCU) 182 configured to control an inverter 129 that is powered by the high voltage batteries 103. The inverter 129 functions to convert the DC current received from the high voltage batteries 103 to alternating current (AC) that can be used by an electric motor. In some examples, the inverter 129 is a high voltage two-phase DC to a high voltage three-phase AC converter. The marine propulsion system also includes an electric motor 124 coupled to a propeller 125. The electric motor 124 is powered by the current received from the inverter 129. The electric motor 124 is an electric traction motor that turns a drive shaft (not shown) that ultimately drives the propeller 125. In some examples, the electric motor is a permanent magnet electric motor. The electric motor 124 is designed to withstand exposure to water and corrosive marine environments, featuring waterproof enclosures, sealed bearings, and corrosion-resistant materials to ensure reliable operation in wet conditions. The electric motor 124 operates quietly, producing minimal noise and vibration compared to traditional combustion engines, which contributes to a quieter boating experience as well as reduced noise pollution in aquatic environments. The electric motor 124 offers high efficiency and energy density, allowing electric boats to achieve comparable performance to traditional boats powered by combustion engines while using less energy and producing fewer emissions.

The outboard PCU 182 includes a printed circuit board (PCB) having a controller 122 (e.g., a microcontroller, central processing unit, or application-specific integrated circuit) that executes computer-readable instructions 127. Such instructions can be loaded from and stored in one or more memory devices collectively referred to as storage 123. Storage 123 may include electrically erasable programmable read-only memory (EEPROM) such as Flash memory (e.g., NAND and NOR flash memory or other types of solid-state memory), dynamic random-access memory (DRAM), static RAM (SRAM), magnetic disk storage, and the like. The storage 123 may be integrated with the controller 122 or provided as a separate memory device coupled to the controller 122.

In a particular embodiment, this integrated PCB also features power-stage drivers, interface circuitry, and connectors for low-voltage lines—such as a 12V power supply stepped down from a DCDC converter (106)—as well as high-voltage sensor inputs and two distinct CAN interfaces. Specifically, an external CAN interface 121 connects the outboard PCU 182 to the vessel's main control network via the external CAN bus 110. For example, the external CAN interface 121 may be a network interface controller configured to send and receive messages in the form of CAN frames over the CAN bus 110. The outboard PCU 182 also includes an internal CAN interface 184 that links to an internal CAN bus 176 connected to localized sensors 128 and actuators (e.g., temperature probes, current detectors, cooling fans, pumps) within the electric motor 124. By adopting this dual-CAN architecture, the outboard PCU can prioritize time-critical signals on the internal bus yet still communicate essential commands and status data to and from the VCU or other external systems.

A principal task of the outboard PCU 182 is power regulation and torque control. When the boat's operator changes throttle inputs—through a throttle control 109 or via the main VCU 108—the corresponding speed or torque command traverses the vessel-wide CAN bus (e.g., CAN bus 110) until it arrives at the outboard PCU 182 via its external CAN interface. When executed by the controller 122, the control program 127 is configured to receive commands from the vessel control unit 108 and control the electric motor 124 in accordance with those commands. For example, the control program 127 is configured to regulate the distribution of electrical energy from the inverter 129 to the electric motor 124. In this example, the control program 127 may receive a throttle/speed command from the vessel control unit 108 and determine the frequency variation or voltage variation that will enter the electric motor 124 for controlling the vessel's speed. The control program 127 is further configured to receive motor state information from various sensors 128 and supply motor state information and diagnostic information to the vessel control unit 108. That is, the control program 127 on the outboard PCU 182 refines the high-level instruction from the VCU or throttle into precise low-level control signals, which drive an inverter 129 or equivalent power electronics embedded in the electric motor 124. In practice, this means the outboard PCU can modulate current, voltage, and switching frequencies to deliver the requested torque or hold the requested speed, all while monitoring real-time system constraints through feedback collected on the internal CAN bus 176.

In addition to managing power and torque, the outboard PCU 182 oversees temperature control by orchestrating cooling activities. Temperature sensors—wired into the outboard's local CAN bus—report motor winding temperatures, power-stage temperatures, fluid temperatures, and even ambient housing temperatures. If any reading surpasses a pre-established threshold set in the outboard PCU firmware (e.g., control program 127), the outboard PCU 182 can automatically activate fans, fluid pumps, or other cooling circuits without waiting on a command from the main VCU 108 or an external operator. This localized action helps avoid overheating scenarios in high-load or high-temperature conditions. Once the electric motor 124 has cooled to within a safe operating range, the outboard PCU 182 may automatically restore full torque, resume standard operation, and advise the main VCU that normal conditions have been reestablished.

In a lower end unit 196, the outboard engine 181 includes a water pump with an impeller 192 configured to draw raw cooling water through a water pump raw water inlet 191. This water is then channeled via a water delivery tube 193 into a cooling system 195, which circulates water to absorb heat from various engine components and ensure efficient thermal management. A drive shaft 194 extends from the electric motor 124, passes through the water pump/impeller 192, and then connects to a gearcase 197 that drives a propeller 125, thereby facilitating vessel propulsion. The water pump generally comprises a pump housing, an impeller, a wear plate, and sealing elements that prevent leaks. The impeller—often a flexible rubber or elastomeric component—relies on its vanes to generate suction at the raw water inlet. As it rotates, the impeller vanes trap and push water through the pump, creating a steady flow into the cooling system 195. The wear plate maintains tight tolerances around the impeller to optimize pumping efficiency, while the housing itself is contoured to maximize water flow. A set of seals protects the drive shaft from moisture intrusion, preventing premature bearing failure or corrosion.

A dedicated water pump controller 198, in communication with the outboard PCU 182, regulates the operation of the water pump/impeller 192 according to real-time temperature measurements and control signals, thereby maintaining optimal operating temperatures. In some embodiments, the pump controller 198 also monitors the pump's operating current to detect whether water is present in the impeller, preventing dry-running (no-flow) conditions that can damage the rubber impeller.

It is essential for the impeller within the water pump to run with water to prevent excessive friction that could cause the rubber or elastomeric vanes to degrade prematurely. Water also serves to carry away heat from the rotating impeller, helping to maintain safe operating temperatures. Running the pump dry compromises its sealing elements, which can lead to leaks or more extensive mechanical damage. Consequently, maintaining a consistent flow of water around the impeller ensures both performance and longevity.

In one embodiment, the water pump controller 198 is a standalone module designed to manage the operational state of the water pump/impeller 192. It is housed in a robust enclosure to protect against moisture and vibration, ensuring reliable performance in the marine environment. The controller 198 interfaces with both the outboard PCU 182 and the internal CAN bus 176, enabling it to receive temperature or flow commands and exchange diagnostic data.

The water pump controller 198 includes a microcontroller 170 configured to execute control program 171 having computer algorithms that determine when the water pump/impeller 192 should be activated, how fast it should operate, and whether sufficient water is present in the system. The microcontroller 170 monitors input signals from multiple sensors (e.g., current sensors, temperature sensors) and applies real-time logic to optimize pump operation, ensuring the impeller remains adequately cooled.

A sensor interface 179, typically comprising one or more analog-to-digital converters (ADCs) and current-sensing components, is coupled to the microcontroller 170. The sensor interface 179 continuously measures the electrical current drawn by the water pump/impeller 192. Deviations from known operating currents—either above or below specific thresholds—can indicate an abnormal condition, such as a clogged inlet 191 or a lack of water flow altogether. These real-time measurements enable the microcontroller 170 to detect dry-running (no-flow) conditions.

A driver stage 178 provides the required power signals to the water pump/impeller 192.

This driver stage 178 can modulate the voltage supplied to the water pump, controlling both the flow rate and pressure of the cooling water. Under normal conditions, the driver stage 178 operates at a predetermined voltage to achieve a stable flow. If the microcontroller 170 detects an abnormal current reading from the sensor interface 179, it can instruct the driver stage 178 to reduce voltage, shut down the pump, or gradually ramp the pump's speed up or down as needed.

Non-volatile memory 163 in the pump controller 198 stores reference current profiles 177, historical data, and operational parameters. These reference profiles 177 help the microcontroller 170 discriminate between normal operating conditions—when the water pump/impeller 192 is sufficiently cooled by raw water—and abnormal conditions caused by blockage or air in the system. Each time the water pump operates, measured current values are compared against the stored profiles, and any discrepancies are logged for diagnostic or maintenance purposes.

In certain embodiments, the pump controller 198 further includes a dedicated CAN interface 183 configured to communicate with the internal CAN interface 184 of the outboard PCU 182 via the internal CAN bus 176. Through this interface 183, the pump controller 198 exchanges status information, diagnostic data, and control signals with the outboard PCU 182, thereby enabling real-time coordination of pump operation based on overall system conditions. Moreover, program instructions 171 stored in the non-volatile memory 163 are executed by the microcontroller 170 to continuously monitor operating parameters—such as current draw and water flow—and to regulate the water pump/impeller 192 accordingly. This includes adjusting pump speed, detecting abnormal flow conditions, and preventing dry-running scenarios, all of which help maintain proper cooling performance and protect the impeller from damage.

In one example scenario, the outboard engine 181 starts in a cold condition, and the pump controller 198 immediately powers the pump at a baseline voltage. The sensor interface 179 reads a current value that matches the stored reference for “full flow” operation. Recognizing normal flow, the microcontroller 170 confirms that the impeller is sufficiently cooled and continues normal operations without interruption.

In a second scenario, debris clogs the raw water inlet 191, causing reduced water flow through the impeller. The sensor interface 179 detects a current reading lower than the stored baseline. In response, the microcontroller 170 commands the driver stage 178 to adjust voltage, attempting to restore normal flow. If the current reading remains below a predetermined threshold, the controller 198 logs a fault and transmits a warning through the internal CAN bus 176, prompting the operator to check the inlet.

A third and fourth scenario involve detecting actual dry-running conditions and subsequent recovery. In a third case, if the impeller momentarily loses its prime (e.g., from an air pocket in the water delivery tube 193), the sensor interface 179 registers abnormally low current. The microcontroller 170 swiftly shuts down the pump or reduces speed to prevent rubber impeller damage. Once conditions normalize, the controller 198 restarts the pump at a reduced voltage to safely reprime the system. In the fourth case, severe overheating may occur if the operator inadvertently runs in shallow water with blocked flow. The pump controller 198 identifies sustained low current for a set duration, triggers a critical fault mode, and communicates directly with the outboard PCU 182 to warn the operator and protect the system until proper water flow is restored.

The outboard PCU 182 not only receives status and diagnostic updates from the pump controller 198 but also provides control instructions based on overall system demands. For instance, when the outboard PCU 182 detects elevated motor temperatures through its internal CAN sensors, it can instruct the pump controller 198 to increase flow by raising pump voltage. Conversely, if diagnostic data on the external CAN bus 110 indicates the vessel is operating at low loads or cooler ambient conditions, the outboard PCU may reduce the pump's duty cycle to conserve energy. This coordinated approach ensures that the entire cooling system, including the water pump/impeller 192, operates efficiently while safeguarding critical components from heat-related damage.

Because key sensors and internal devices within the electric motor 124 reside on the internal CAN bus 176, the outboard PCU 182 can rapidly gauge operational health, spot faults, and react to environmental shifts. For instance, if a voltage sensor connected to the high-voltage battery line reports a sudden dip (potentially indicating a partial battery depletion or a transient line fault), the outboard PCU 182 can quickly reduce torque output to avert a critical undervoltage event. Similarly, if current readings become unexpectedly high, the outboard PCU 182 can impose a stepped torque reduction or even a controlled motor shutdown, sending a diagnostic alert through the external CAN bus 110 so the operator sees a clear status indicator on their dashboard or VCU interface.

For further explanation, FIG. 1C sets forth a block diagram of an example of the high voltage battery 103 in accordance with at least one embodiment of the present disclosure. The example high voltage battery 103 of FIG. 1C includes a CAN interface 131 for coupling the high voltage battery 103 to the CAN bus 110. For example, the CAN interface 131 may be a network interface controller configured to send and receive messages in the form of CAN frames over the CAN bus 110. The example high voltage battery 103 includes array of battery cells 135 organized into battery modules 140 or battery packs, and a set of battery contactors 137 that selectively couple the battery modules 140 to high voltage terminals 138 of the battery 103.

The example high voltage battery 103 also includes a battery management system (BMS) 134 comprising a battery management controller 132 coupled to the CAN interface 131. Battery management controller 132 may include or implement a processor, a microcontroller, an ASIC, PLA such as an FPGA, or other data processing unit in accordance with the present disclosure. In some examples, battery management controller 132 is implemented by a processor or central processing unit configured to execute computer programming instructions, also referred to a computer executable instructions or processor executable instruction. Such instructions can be loaded from and stored in one or more memory devices collectively referred to as storage 133. Storage 133 may include EEPROM such as Flash memory (e.g., NAND and NOR flash memory or other types of solid-state memory), DRAM, SRAM, magnetic disk storage, and the like. The battery management system 134 further includes a variety of sensors 130 coupled to battery cells and other battery components for collecting battery state information. The storage 133 may be integrated with the battery management controller 132 or provided as a separate memory device coupled to the battery management controller 132.

The BMS 134 includes a control program 139 embodied in computer programing instructions stored in tangible persistent storage of storage 133. In some examples, the control program 139 controls the state of the battery contactors for selectively coupling and decoupling the battery modules 140 to the high voltage terminals 138 of the battery 103. In some examples, the control program 139 also monitors battery state information such as voltage, current, and temperature in battery cells 135 via the above-mentioned sensors. In some examples, the control program 139 also communicates with the vessel control unit 108 to provide battery state information. The control program also controls the charging of the battery cells 135.

For further explanation, FIG. 1D sets forth a block diagram of an example of the PDU 104 in accordance with at least one embodiment of the present disclosure. The example PDU 104 of FIG. 1D includes a CAN interface 141 for coupling the PDU 104 to the CAN bus 110. For example, the CAN interface 141 may be a network interface controller configured to send and receive messages in the form of CAN frames over the CAN bus 110. The PDU 104 also includes a battery interface 144 coupling the high voltage batteries 103 to a switching system 145 of the PDU 104, a charge port interface 150 coupling the charging port 105 to the switching system 145, a motor interface 147 coupling the marine propulsion system 102 to the switching system 145, and a DCDC interface 148 coupling the DCDC converter 106 to the switching system 145. The switching system 145 includes a set of contactors (not shown for simplicity) by which the PDU 104 supplies power from the high voltage batteries 103 to the marine propulsion system 102 and to the DCDC converter 106, or supplies power from the charging port 105 to the high voltage batteries 103.

The example PDU 104 also includes a controller 142 that may include or implement a processor, a microcontroller, an ASIC, PLA such as an FPGA, or other data processing unit in accordance with the present disclosure. In some examples, the controller 142 is implemented by a processor or central processing unit configured to execute computer programming instructions, also referred to a computer executable instructions or processor executable instruction. Such instructions can be loaded from and stored in one or more memory devices collectively referred to as storage 143. Storage 143 may include EEPROM such as Flash memory (e.g., NAND and NOR flash memory or other types of solid-state memory), DRAM, SRAM, magnetic disk storage, and the like. The storage 143 may be integrated with the controller 142 or provided as a separate memory device coupled to the controller 122.

The PDU 104 also includes a control program 149 embodied in computer programing instructions stored in tangible persistent storage of storage 143. When executed by the controller 142, the control program 149 is configured to receive commands from the vessel control unit 108 and control the switching system 145 to connect and disconnect power supplied to vessel components. The control program 149 is also configured to provide state information to vessel control unit 108. State information can be collected using one or more sensors 157.

For further explanation, FIG. 1E sets forth a block diagram of an example of vessel control unit 108 in accordance with at least one embodiment of the present disclosure. The example vessel control unit 108 of FIG. 1E includes a CAN interface 151 for coupling the vessel control unit 108 to the CAN bus 110. For example, the CAN interface 151 may be a network interface controller configured to send and receive messages in the form of CAN frames over the CAN bus 110.

The example vessel control unit 108 also includes a controller 152 that may include or implement a processor, a microcontroller, an ASIC, PLA such as an FPGA, or other data processing unit in accordance with the present disclosure. In some examples, controller 152 is implemented by a processor or central processing unit configured to execute computer programming instructions, also referred to a computer executable instructions or processor executable instruction. Such instructions can be loaded from and stored in one or more memory devices collectively referred to as storage 153. Storage 153 may include EEPROM such as Flash memory (e.g., NAND and NOR flash memory or other types of solid-state memory), DRAM, SRAM, magnetic disk storage, and the like. The storage 153 may be integrated with the controller 152 or provided as a separate memory device coupled to the controller 152.

The vessel control unit 108 also includes a control program 154 embodied in computer programing instructions stored in tangible persistent storage of storage 153. When executed by controller 152, the control program 154 is configured to send commands to other vessel components and receive state information and diagnostic data from vessel components as discussed above.

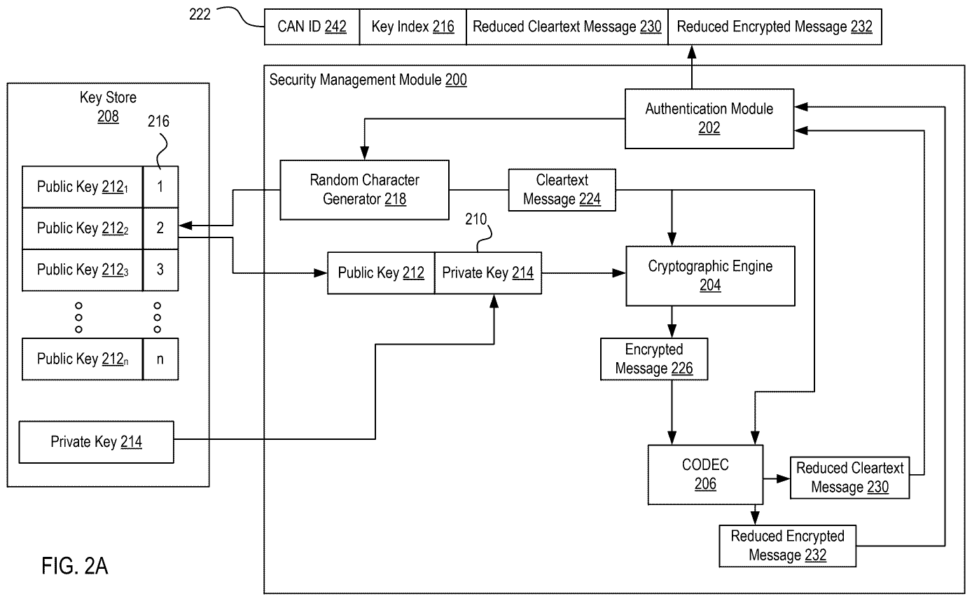

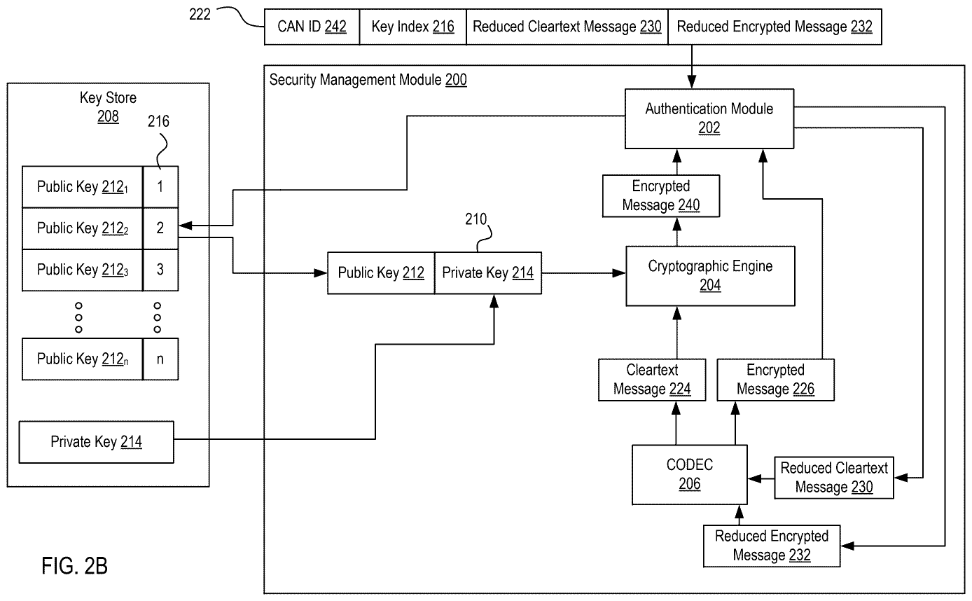

For further explanation, FIG. 2A sets forth an example security management module 200 for authenticating powertrain components of an electric vessel by a battery management controller in accordance with at least one embodiment of the present disclosure. In some examples, the security management module 200 is embodied in a set of computer programing instructions that are stored in a memory (e.g., the storage of FIGS. 1B-1E) that, when executed by a processor, cause the processor to implement the operations described below. In other examples, the security management module 200 may be implemented in digital logic, such as an application specific integrated circuit or programmable logic device.

The security management module 200 of a particular vessel component expects to receive an authentication message from one or more other vessel components. If an expected authentication message is not received, the security management module 200 signals a security error. For example, the list of vessel components for which the authentication message is expected may be stored in a memory device. The list may be a list of CAN identifiers corresponding to the vessel components for which the authentication message is expected. The security management module expects the authentication message at startup or system initialization. Thereafter, the security management module 200 may expect the authentication message based on an authentication schedule, which may be based on a timer. For example, if the security management module 200 does not receive the authentication message by the end of a timeout period since the last authentication message, the security management module 200 may signal a security error. The security management module 200 also authenticates each vessel component for which an authentication message is expected. The authentication of a vessel component is described in more detail below. If authentication of a vessel component fails, the security management module 200 may signal a security error. In response to detecting the security error, the vessel may be disabled. The mechanism for disabling the vessel may depend upon the vessel component that detects the security error, as described below.

In the example of FIG. 2A, the security management module 200 includes a cryptographic engine 204 configured to encrypt and decrypt data. For example, the cryptographic engine 204 can implement the AES128 encryption algorithm to encrypt and decrypt data. It will be appreciated by those of skill in the art that AES128 is discussed as an illustrative example and that a cryptographic engine 204 in accordance with the present disclosure can be implemented using other encryption algorithms and key lengths. For encryption and decryption, the cryptographic engine 204 uses an encryption key 210 stored in a key store 208. The key store 208 is replicated on each genuine component of the vessel. In some examples, an encryption key 210 is produced by concatenating a public key 212 and a private key 214. For example, the public key 212 and the private key 214 are each 64-bit keys. In some implementations, the key store 208 includes multiple public keys 212₁₋ₙ that are each associated with a key index 216. To produce an encryption key 210, the cryptographic engine 204 selects one of the public keys 212₁₋ₙ based on the key index 216 (e.g., generated at random or provided in an authentication message, as discussed below), and concatenates the selected public key with the private key to produce a 128-bit encryption key. In some examples, the key store 208 is implemented by a data structure stored a memory device, such as any of the memory devices previously discussed. In some implementations, the private key 214 is stored separately in a secure storage device (not shown). In some examples, the private key 214 is encoded in all genuine components that are produced for the vessel. Thus, the private key 214 is pre-shared among the vessel components. The cryptographic engine 204 encrypts and decrypts messages using the encryption key 210. For example, a 128-bit encryption key is used to encrypt or decrypt a 128-bit message; however, these key lengths and message lengths are provided for illustrative purposes only. It will be appreciated that other key lengths, message lengths, and encryption algorithms may be employed. Additional explanations regarding encryption keys for encryption and decryption by the cryptographic engine 204 is provided below.

In the example of FIG. 2A, the security management module 200 also includes an encoder/decoder (‘codec’) 206 configured to encode and decode data in accordance with a particular scrambling protocol. For example, to scramble message data, codec 206 selects a subset of bytes of the message, where the byte positions in the data are preconfigured. In one example where 16 bytes of message data are input to the codec 206, the codec 206 selects byte 0, byte 7, byte 8, and byte 15 of the data to reduce the 16-byte message to a 4-byte message. To descramble data, codec 206 receives a subset of bytes of a message and reconstructs the message data from the subset of bytes using a descrambling mechanism. For example, knowing a priori the byte positions of the subset of bytes within the message to be decoded, the descrambling mechanism applies a particular order of XOR, SUM, and SHIFT operations to generate the missing bytes and reconstruct the original message data. In one example, codec 206 receives 4 bytes of message data. Knowing that the 4 bytes correspond to byte 0, byte 7, byte 8, and byte 15 and of the original message data, codec 206 applies the XOR, SUM, and SHIFT operations of the descrambling mechanism to generate the missing bytes of the 16-byte message data.

In the example of FIG. 2A, the security management module 200 also includes a random character generator 218. In some examples, the random character generator 218 generates a random number, or random text that is hashed to create a random number, which can be used as a key index 216 to select a public key 212. In some examples, the random character generator 218 can be used to generate cleartext for an authentication message, which is described in more detail below.

In the example of FIG. 2A, the security management module 200 also includes an authentication module 202 configured to generate authentication messages and authenticate vessel components based on received authentication messages. The operation of the security management module 200 to generate an authentication message 222 is now described. In response to a particular trigger (e.g., a timer or the receipt of an authentication message from another vessel component), the authentication module 202 initiates the generation of the authentication message 222 by requesting a random number from the random character generator 218. The authentication module 202 uses the random number as the key index 216 (e.g., ‘2’) to select a public key 212 (e.g., public key 212₂) from the key store 208. However, in alternative examples, a timer synchronized to the reception of the last CAN frame can be used to generate a random number. The public key 212 is concatenated with the private key 214 to produce the encryption key 210, which is supplied to the cryptographic engine 204.

The authentication module 202 also requests randomly generated text for a cleartext message 224 (e.g., 16 bytes of cleartext) from the random character generator 218. The cleartext message 224 is supplied to the cryptographic engine 204 and to codec 206. The cryptographic engine 204 encrypts the cleartext message 224 using the encryption key 210 to generate an encrypted message 226 (e.g., 16 bytes), which is provided to codec 206. Codec 206 encodes the cleartext message 224 and the encrypted message 226 by reducing the message based on selected byte positions, as discussed above. For example, codec 206 selects byte 0, byte 7, byte 8, and byte 15 of the cleartext message 224 to generate a reduced cleartext message 230 (4 bytes) and selects byte 0, byte 7, byte 8, and byte 15 of the encrypted message 226 to generate a reduced encrypted text message 232 (4 bytes). It will be appreciated that the number of bytes and byte positions used to reduce a message are provided for illustrative purposes only.

The authentication module 202 generates the authentication message 222 by constructing a CAN frame that includes the key index 216, the reduced cleartext message 230, and the reduced encrypted message 232. The authentication message 222 is then transmitted over the CAN bus. In some examples, the authentication message 222 also includes an identifier, such as a CAN identifier, of the vessel component transmitting the authentication message 222.

For further explanation, FIG. 2B illustrates the operation of the security management module 200 to authenticate another vessel component based on an authentication message 222 received from that vessel component. In some examples, the authentication message includes the CAN identifier 242 of the vessel component, a key index 216, the reduced cleartext message 230, and the reduced encrypted message 232. The reduced cleartext message 230 is provided to the codec 206, which reconstructs the cleartext message 224 from the reduced cleartext message 230 based on the known mapping between the bytes of the reduced cleartext message 230 and their byte positions within the cleartext message 224, and further by application of the descrambling mechanism to supply the missing bytes. Likewise, the reduced encrypted message 232 is provided to the codec 206, which reconstructs the encrypted message 226 from the reduced encrypted message 232 based on the known mapping between the bytes of the reduced encrypted message 232 and their byte positions within the encrypted message 226, and further by application of the descrambling mechanism to supply the missing bytes.

The key index 216 provided in the authentication message 222 is used to identify a public key 212 from the key store 208. The authentication module 202 concatenates the corresponding public key 212 with the private key 214 to produce the encryption key 210, which is supplied to the cryptographic engine 204. The cleartext message 224 is also supplied to the cryptographic engine 204, which encrypts the cleartext message 224 to generate another encrypted message 240. The authentication module 202 then compares the received encrypted message 226 to the generated encrypted message 240 to determine whether they are identical. If the encrypted message 226 and the encrypted message 240 are identical, the vessel component associated with the CAN identifier 242 in the authentication message 222 is authenticated, in that the security management module 200 determines that the vessel component is a genuine component. If the encrypted message 226 and the encrypted message 240 are not identical, the security management module 200 may signal to a vessel component controller that one or more vessel components have failed authentication, which allows the vessel component controller to perform an error handling action.

Although the authentication protocol described above includes comparing the received encrypted message 226 to the encrypted message 240 generated by encrypting the cleartext message 224, in alternative implementations the authentication module 202 can decrypt the encrypted message 226 to generate cleartext, and compare that cleartext to the cleartext message 224.

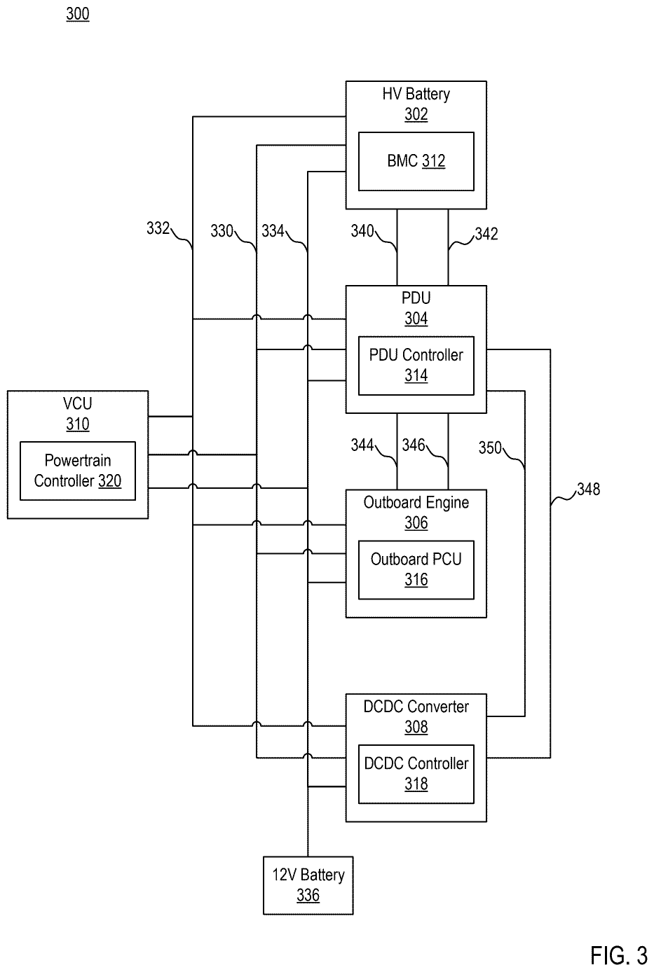

For further explanation, FIG. 3 sets forth an example connection architecture 300 for an example of a distributed control system in an electric vessel. The example architecture 300 includes one or more HV batteries 302 having a BMC 312. Only one HV battery 302 is shown in FIG. 3 for simplicity, although it will be appreciated that architecture 300 may include more than one battery that is connected to system components in the manner that HV battery 302 is connected. In some examples, the HV battery 302 and BMC 312 implement the battery 103 and BMC 132 shown in FIGS. 1A and 1C. In various examples, BMC 312 is implemented by a microcontroller, a processor coupled to a memory, or other digital logic device that will be appreciated by those of skill in the art. As will be discussed in further detail below, BMC 312 implements battery control operations such as opening and closing power contactors, battery state monitoring, and so on.

Architecture 300 also includes a PDU 304 having a PDU controller 314. In some examples, the PDU 304 and PDU controller 314 implement the PDU 104 and PDU controller 142 shown in FIGS. 1A and 1D. In various examples, PDU controller 314 is implemented by a microcontroller, a processor coupled to a memory, or other digital logic device that will be appreciated by those of skill in the art. As will be discussed in further detail below, PDU controller 314 implements PDU control operations such as selectively opening and closing power contactors coupled to the HV battery 302 and motor in accordance with VCU commands and detected faults. PDU 304 is coupled directly to HV battery 302 by high voltage cables 340, which may include, for example, an HV+ cable and an HV-cable. PDU 304 is also coupled directly to HV battery 302 by HVIL wiring 342, which may include two HVIL wires that are part of an HVIL fault detection loop between HV battery 302 and PDU 304.

Architecture 300 also includes electric outboard engine 306 having an outboard power control unit (PCU) 316. In some examples, outboard engine 306 and outboard PCU 316 implement outboard engine 181 and PCU 182 of FIG. 1B. In various examples, outboard PCU 316 is implemented by a microcontroller, a processor coupled to a memory, or other digital logic device that will be appreciated by those of skill in the art. As will be discussed in further detail below, outboard PCU 316 implements outboard control operations such as opening and closing power contactors, motor state monitoring, motor speed, propeller direction, and so on. Outboard engine 306 is coupled directly to PDU 304 by high voltage cables 344, which may include, for example, an HV+ cable and an HV-cable. Outboard engine 306 may be coupled directly to PDU 304 by HVIL wiring 346, which may include two HVIL wires that are part of an HVIL fault detection loop between outboard engine 306 and PDU 304.

Architecture 300 also includes a DCDC converter 308 having a DCDC controller 318. In some examples, DCDC converter 308 implements DCDC converter 106 in FIG. 1A. In various examples, DCDC controller 318 is implemented by a microcontroller, a processor coupled to a memory, or other digital logic device that will be appreciated by those of skill in the art. As will be discussed in further detail below, DCDC controller 318 implements DCDC converter operations such as charge cycling of a low voltage battery, such as 12V battery 336, as well as supplying power to auxiliary systems. DCDC converter 308 is coupled directly to PDU 304 by high voltage cables 348, which may include, for example, an HV+ cable and an HV-cable. DCDC converter 308 is coupled directly to PDU 304 by HVIL wiring 350, which may include two HVIL wires that are part of an HVIL fault detection loop between DCDC converter 308 and PDU 304.

Architecture 300 also includes a VCU 310 having a powertrain controller 320. In some examples, VCU 310 and powertrain controller 320 implement VCU 108 and controller 152 in FIGS. 1A and 1E. In various examples, powertrain controller 320 is implemented by a microcontroller, a processor coupled to a memory, or other digital logic device that will be appreciated by those of skill in the art. As will be discussed in further detail below, powertrain controller 320 implements powertrain control commands and state monitoring of powertrain components such as HV battery 302, PDU 304, outboard engine 306, and DCDC converter 308. VCU 310 is coupled to HV battery 302, PDU 304, outboard engine 306, and DCDC converter 308 via ignition wire 332. VCU 310 provides an ignition signal using ignition wire 332 by, for example, asserting a voltage on ignition wire 332 that is above a threshold voltage for detection of an ignition signal by a powertrain component. The ignition signal is used to wake up the controllers of the powertrain components, namely, BMC 312, PDU controller 314, outboard PCU 316, and DCDC controller 318.

In architecture 300, VCU 310, HV battery 302, PDU 304, and outboard engine 306 are coupled to low voltage power bus 334. As used herein, ‘low voltage’ is contrasted with high voltage supplies of the high voltage batteries, and may refer to a voltage supply of 24V or less. The low voltage power bus 334 can include, for example, a 12V supply wire and a ground wire for reference potential. The 12V supply may be provided by DCDC converter 308, which steps down the high voltage supply from HV battery 302 to a 12V (or other low voltage level) that is usable by vessel electronics and auxiliary systems. Alternatively, the 12V supply can be provided by a 12V battery 336 that is charged by the DCDC converter 308. In various examples, the low voltage power bus 334 provides power to BMC 312, PDU controller 314, outboard PCU 316, and VCU powertrain controller 320, as well as power to relays, power contactors, sensors, and other electronic and electromechanical components of the HV battery 302, PDU 304, outboard engine 306, and VCU 310.

VCU 310 is coupled to HV battery 302, PDU 304, outboard engine 306, and DCDC converter 308 via a CAN bus 330. In some examples, CAN bus 330 implements CAN bus 110 of FIG. 1A. All commands and data communication between powertrain components are sent over CAN bus 330 and are implemented through CAN frames, eliminating traditional control wiring. The CAN bus can be implemented using industry-standard protocols such as CAN 2.0 or CAN FD (Flexible Data-rate). In some examples, the bus wiring includes a twisted pair to ensure signal integrity and minimize electromagnetic interference. In some examples, the physical layer can conform to ISO 11898-2 or ISO 11898-3 standards for high-speed or fault-tolerant operation, respectively. Each component on the CAN bus has a unique identifier, allowing precise addressing and prioritization of messages.

In the CAN bus system of FIG. 3, each component is assigned a unique identifier (ID).

This identifier is included in the frame header of every message sent over the bus. The identifier can serve two purposes: addressing and prioritization. In a particular embodiment, higher priority messages can be assigned lower numerical IDs and gain access to the bus in case of arbitration conflicts. This ensures time-critical commands, such as motor speed adjustments, are executed without delay.

In some examples, each CAN frame is composed of a header and a data payload. In some examples, the header that includes the identifier, control bits, and data length information. The header ensures that messages are delivered to the intended component while enabling efficient arbitration. The identifier also allows for message filtering, where each device processes only the messages relevant to its operation, ignoring others to reduce processing overhead.

The CAN bus 330 is composed of multiple signal wires, which can include a CAN-high wire that carries the positive differential signal and a CAN-low wire that carries a negative differential signal, which forms a differential pair that minimizes noise. In some examples, the CAN bus signal wires include power supply wire to provide low-voltage power (VCC) to devices on the CAN bus 330 that lack a power supply or where the power supply is disconnected. In these examples, the CAN bus signal wires include a ground wire to provide a reference voltage and ensure signal integrity by reducing electromagnetic interference. Further, the CAN wiring may be sheathed in shielding to protect the signal wiring from interference, and which may be connected to ground.

In some examples, VCU 310 sends commands to HV battery 302 over CAN bus 330 to open or close contactors in the PDU to manage the connection between the batteries and the electric motor, adjust the speed of the electric motor by sending appropriate control signals, open or close contactors in the batteries to control power availability, and so on. Types of commands to HV battery 302 can include commands to open or close the main contactor, enable or disable battery output, request state of charge (SoC) or state of health (SoH) data, perform a diagnostic self-test, and/or enter or exit a low-power or storage mode, and so on. Other types of commands could include commands to adjust a charging rate or mode (e.g., fast charge, trickle charge), activate or deactivate thermal management systems, and/or perform a firmware update or controller reset. BMC 312 independently manages and controls the opening of closing of contactors in response to commands as well as automatic opening of specific contactors in response to detecting HVIL faults. In some examples, no other control signals are provided from VCU 310 to HV battery 302 other than the ignition signal over ignition wire 332 and control commands over CAN bus 330. In other words, neither VCU 310 nor any other device exerts direct control over the contactor states of the HV battery contactors, as full control of battery is vested in BMC 312. Further, BMC 312 independently manages the cooling and charge states of battery cells in HV battery 302.

HV battery 302 also reports state information to VCU 310 over CAN bus 330. For example, such state information can include an SoC indicating current charge level, typically expressed as a percentage, and overall condition of the battery, indicating its capacity relative to its original capacity, the current voltage of the battery pack or individual cells, current being supplied or drawn by the battery, and temperature readings within the battery pack and individual cells to prevent overheating. The state information reported can also include information such as the power output being delivered by the battery in watts or kilowatts, connection status indicating whether the battery is connected or disconnected via its contactors, and/or internal resistance within the battery, which can indicate degradation over time. The state information reported can also include information such as fault or error codes including diagnostic information indicating issues such as overvoltage, undervoltage, and/or short circuits, as well as safety alarms for critical conditions like thermal runaway, overcurrent, and/or voltage imbalances. The state information reported can also include information such as the number of charge-discharge cycles the battery has undergone and whether the battery is charging, discharging, or idle.

In some examples, VCU 310 sends commands over to PDU 304 over command bus 330 to open or close specific power contactors, enable or disable power distribution to the outboard engine 306, execute a safety shutdown in response to faults reported by other components, report diagnostic information, and/or perform a firmware update or controller reset, and so on. PDU controller 314 independently manages and controls the opening of closing of contactors in response to commands as well as automatic opening of specific contactors in response to detecting HVIL faults. In some examples, no other control signals are provided from VCU 310 to PDU 304 other than the ignition signal over ignition wire 332 and control commands over CAN bus 330. In other words, neither VCU 310 nor any other device exerts direct control over the contactor states of the PDU contactors, as full control of the PDU is vested in the PDU controller 314.

PDU 304 also reports state information to VCU 310 over CAN bus 330. For example, such state information can include operational status such as active, idle, or fault. The state information reported can include contactor statuses, including the open/closed state of each contactor and faults or malfunctions in contactor operation, as well as connection status such as which HV batteries are currently connected or disconnection and the connection status to outboard engine 306. In some examples, such state information reported can include power flow metrics such as real-time power being distributed, voltage and current being supplied to outboard engine 306, and voltage and current being received from each HV battery. In some examples, state information reported can include temperature readings to monitor temperature within the PDU for overheating or temperatures of individual components such as contactors and relays. In some examples, the state information reported can include fault or error conditions such as overcurrent condition, overvoltage or undervoltage conditions, and short circuit detection. In some examples, the state information reported can include the state of the HVIL and faults or interruptions of the HVIL circuit as well as other alerts for conditions requiring immediate attention (e.g., thermal issues, electrical faults, etc.).

In some examples, VCU 310 sends commands to outboard engine 306 over CAN bus 330 to increase or decrease motor speed (RPM), increase or decrease torque, reverse or forward propeller rotation, report real-time diagnostics or error codes, execute predefined performance modes (e.g., economy, sport), and/or perform a firmware update or controller reset, and so on. Outboard engine 306 independently manages and controls the opening of closing of contactors in response to commands as well as automatic opening of specific contactors in response to detecting HVIL faults. In some examples, no other control signals are provided from VCU 310 to outboard engine 306 other than the ignition signal over ignition wire 332 and control commands over CAN bus 330. In other words, neither VCU 310 nor any other device exerts direct control over the contactor states of the motor contactors and speed/torque of the propeller. Outboard PCU 316 independently manages and controls the propeller speed, torque, and direction, as well as the cooling of propulsion system components.

Outboard engine 306 also reports state information to VCU 310 over CAN bus 330. In some examples, the state information reported can include an operational status (e.g., active, idle, or fault mode) of the outboard engine 306, motor speed and RPM, instantaneous torque output, and/or direction of rotation (e.g., forward or reverse). In some examples, the state information reported can also include real-time power consumption in watts or kilowatts, real-time voltage and current draw, internal motor temperature to prevent overheating, error codes and diagnostics to indicate operational issues, and/or efficiency metrics (e.g., percentage efficiency or power losses). In some examples, the state information reported can include the state of the HVIL and faults or interruptions of the HVIL circuit as well as other alerts for conditions requiring immediate attention (e.g., thermal issues, electrical faults, etc.).

In some examples, VCU 310 sends commands to DCDC converter 308 to report diagnostic information, enable or disable power to auxiliary systems, open or close contactors, and so on. DCDC converter 308 also reports state information to VCU 310 over CAN bus 330. In some examples the state information for the DCDC converter 308 includes real-time output voltage and current, input voltage, and power metrics such as input power, output power, and conversion efficiency. In some examples, the state information reported includes temperature readings for thermal management, operational status (e.g., active, idle, fault), and safety alarms for conditions like overvoltage, undervoltage, overcurrent, or thermal shutdown. In some examples, the state information reported includes diagnostic fault codes, and connection statuses to the low voltage battery and auxiliary systems. In some examples, the state information reported can include the state of the HVIL and faults or interruptions of the HVIL circuit as well as other alerts for conditions requiring immediate attention (e.g., thermal issues, electrical faults, etc.).

Each powertrain component's controller processes the received CAN commands and independently executes the required action without further control by VCU 310 or any other device. For example, the motor controller adjusts speed based on the VCU's commands, while the PDU controller controls contactor opening and closing to enable safe operation. VCU 310 has no direct controller DCDC contactor opening/closing, as full control of the DCDC converter is vested in DCDC controller 318.

In this way, the distributed control architecture in accordance with the present disclosure reduces complexity by utilizing a CAN bus for control, and the invention eliminates the need for traditional wiring, reducing system complexity and weight. The distributed control architecture in accordance with the present disclosure enhances reliability by ensuring that each component operates independently while being coordinated by the VCU. The distributed control architecture in accordance with the present disclosure improves safety with HVIL connections that provide a robust safety mechanism, preventing accidental operation and ensuring proper system integration. The distributed control architecture in accordance with the present disclosure improves scalability in that the modular design allows easy integration of additional components or functionalities without significant redesign.

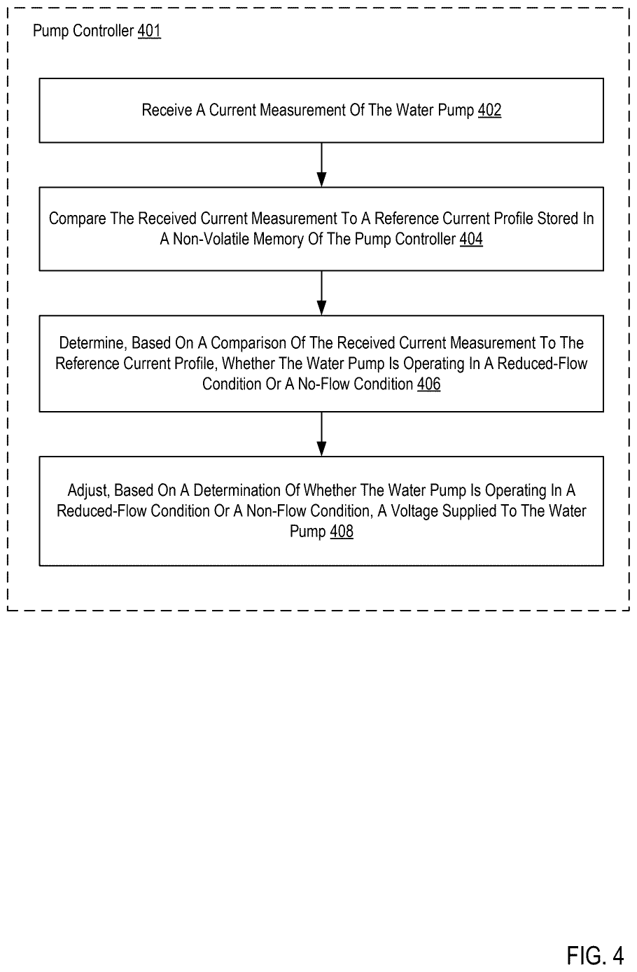

For further explanation, FIG. 4 sets forth a flow chart of an example method of adaptive control of a water pump in a marine propulsion system in accordance with at least one embodiment of the present disclosure. The method of FIG. 4 includes receiving 402, by a pump controller 401, a current measurement of the water pump. In one embodiment, the pump controller 401 obtains a current measurement from a dedicated current sensor connected in series with the water pump. The sensor interface periodically samples the pump's current draw at predetermined intervals. A microcontroller or logic circuit then retrieves the sampled value via a digital data bus. Finally, the measurement is stored in a local memory for comparison with reference operating.

The method of FIG. 4 also includes comparing 404, by the pump controller 401, the received current measurement to a reference current profile stored in a non-volatile memory of the pump controller. Comparing 404, by the pump controller 401, the received current measurement to a reference current profile stored in a non-volatile memory of the pump controller may be carried out by first retrieving the baseline current data from the non-volatile memory and loading it into a working buffer. Next, the microcontroller executes a side-by-side comparison between the newly acquired current measurement and the reference profile to detect any deviation beyond predefined thresholds. These thresholds, in turn, define whether the pump's operation is categorized as normal condition, reduced-flow condition, or no-flow condition. If a significant deviation is identified, the microcontroller triggers an internal event or error code, prompting corrective measures such as reducing voltage or temporarily shutting down the pump.

In addition, the method of FIG. 4 includes determining 406, based on a comparison of the received current measurement to the reference current profile, by the pump controller 401, whether the water pump is operating in a reduced-flow condition or a no-flow condition. Determining 406, based on a comparison of the received current measurement to the reference current profile, by the pump controller 401, whether the water pump is operating in a reduced-flow condition or a no-flow condition may be carried out by evaluating whether the measured current exceeds, matches, or falls below specific threshold ranges stored in the reference profile. If the measured current remains within a predefined normal range, the control logic deems the flow condition normal. If the measured current stays below the normal range over a set duration, the logic classifies the condition as reduced-flow or no-flow. Once the condition is classified, the pump controller initiates the appropriate response, such as modulating voltage or initiating a safe shutdown.

In certain implementations, the pump controller 401 maintains at least two distinct baseline current thresholds to distinguish between reduced-flow and no-flow. Reduced-flow is typically indicated by a moderate drop below the normal operating current range, suggesting partial blockage or restricted intake. No-flow, on the other hand, is detected when the measured current approaches near-zero or remains below a critical limit for a set time interval, indicating a complete loss of water flow. By maintaining these separate thresholds, the controller can initiate less aggressive corrective measures (e.g., adjusting voltage or logging a minor fault) for reduced-flow conditions, while imposing immediate shutdown or critical fault protocols upon detecting a no-flow scenario to protect the impeller from dry-running damage.

The method of FIG. 4 also includes adjusting 408, based on a determination of whether the water pump is operating in a reduced-flow condition or a non-flow condition, by the pump controller 401, a voltage supplied to the water pump. Adjusting 408, based on a determination of whether the water pump is operating in a reduced-flow condition or a non-flow condition, by the pump controller 401, a voltage supplied to the water pump may be carried out by dynamically modulating the driver stage's output levels under firmware control. Upon detecting a reduced-flow condition, the microcontroller lowers the applied voltage to restore normal flow while minimizing potential impeller damage. If a no-flow condition is identified, the microcontroller either shuts down the pump entirely or applies a minimal holding voltage. These corrective actions are logged internally and communicated to the outboard PCU through a dedicated CAN interface for system-wide coordination.

These pump controller functions offer a novel approach to intelligent water pump management in marine propulsion systems. By continuously monitoring current draw and automatically distinguishing between reduced-flow and no-flow conditions, the controller tailors corrective actions precisely to the degree of flow impairment. This targeted response reduces unnecessary pump shutdowns while still preserving the impeller's integrity in severe conditions. Moreover, the adaptive control of pump voltage and speed in response to real-time data enables higher energy efficiency and avoids wasteful operation. Detailed logging of events and CAN-based communication further enhance diagnosability, allowing for rapid intervention and performance optimization. Collectively, these features safeguard the impeller from premature wear, minimize downtime, and extend the overall service life of the water pump.

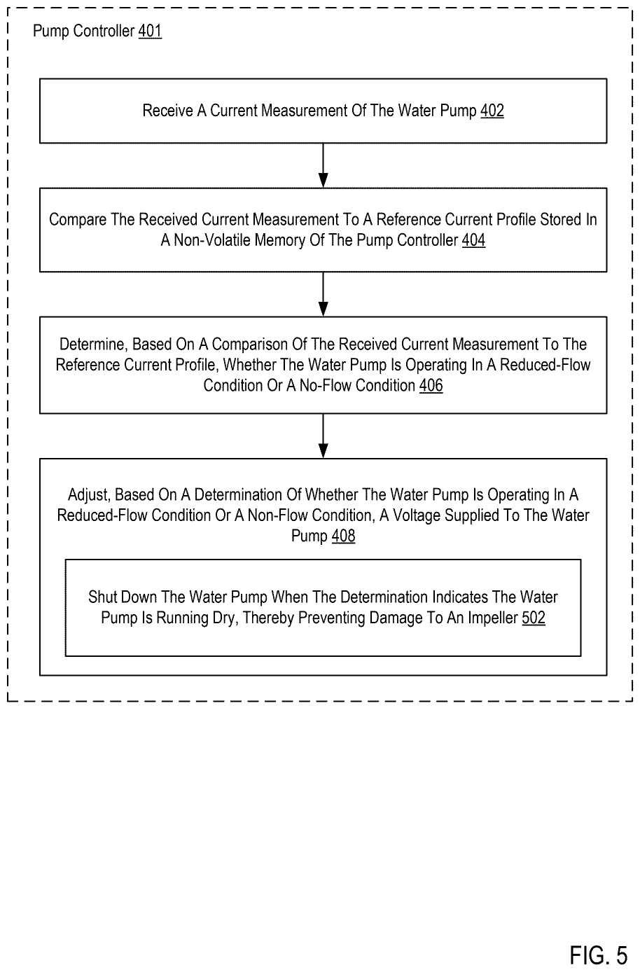

For further explanation, FIG. 5 sets forth a flow chart of another example method of adaptive control of a water pump in a marine propulsion system in accordance with at least one embodiment of the present disclosure. The method of FIG. 5 expands on the method of FIG. 4 in that the method of FIG. 5, adjusting 408, based on a determination of whether the water pump is operating in a reduced-flow condition or a non-flow condition, by the pump controller 401, a voltage supplied to the water pump includes shutting down 502, by the pump controller 401, the water pump when the determination indicates the water pump is running dry, thereby preventing damage to an impeller. Shutting down 502, by the pump controller 401, the water pump when the determination indicates the water pump is running dry, thereby preventing damage to an impeller may be carried out by continuously monitoring the measured current for abnormally low values that persist beyond a configured time threshold. If the real-time measurement remains below the no-flow threshold for the set duration, the microcontroller triggers an automatic stop command. This command instructs the driver stage to cut off power to the pump, thereby preventing frictional heat buildup and potential damage to the rubber impeller. Additionally, the event is logged in non-volatile memory and a status message is transmitted to the outboard PCU via the CAN interface for diagnostic monitoring.

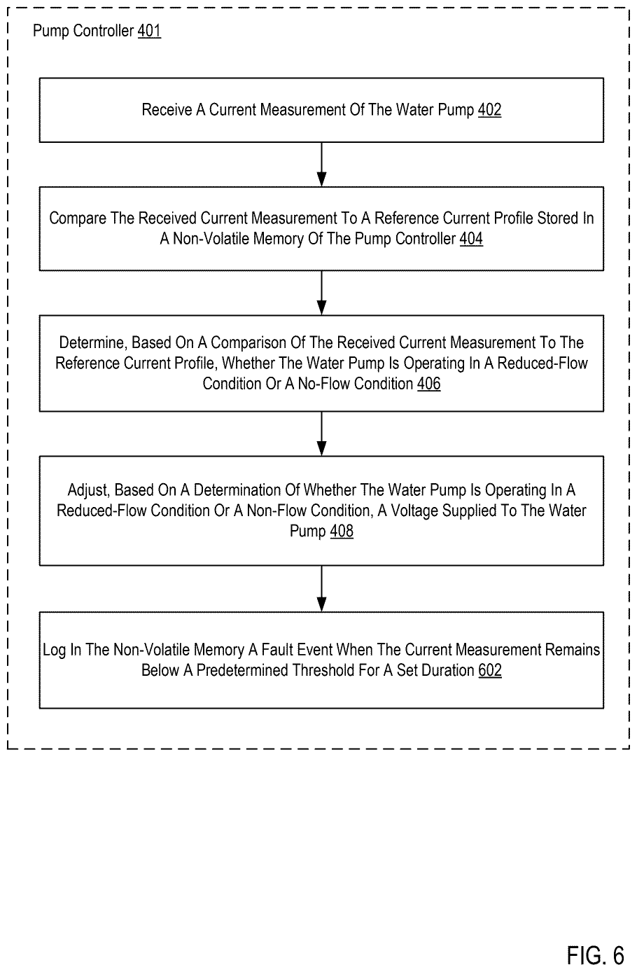

For further explanation, FIG. 6 sets forth a flow chart of another example method of adaptive control of a water pump in a marine propulsion system in accordance with at least one embodiment of the present disclosure. The method of FIG. 6 expands on the method of FIG. 5 by including logging 602 in the non-volatile memory a fault event when the current measurement remains below a predetermined threshold for a set duration. Logging 602 in the non-volatile memory a fault event when the current measurement remains below a predetermined threshold for a set duration may be carried out by continuously monitoring the measured current against the threshold at defined time intervals. If the current remains below the threshold for the entire duration, a fault flag is set within the microcontroller. The microcontroller then writes a corresponding fault code and timestamp to the non-volatile memory. Finally, a diagnostic message is queued for transmission to the outboard PCU through the CAN interface.

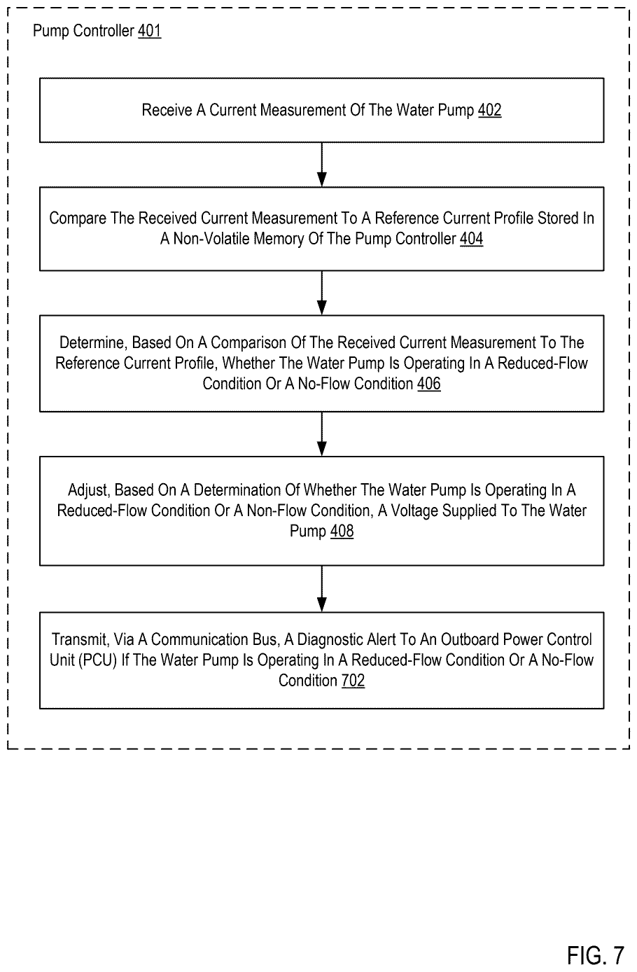

For further explanation, FIG. 7 sets forth a flow chart of another example method of adaptive control of a water pump in a marine propulsion system in accordance with at least one embodiment of the present disclosure. The method of FIG. 7 expands on the method of FIG. 5 by including transmitting 702, via a communication bus, a diagnostic alert to an outboard power control unit (PCU) if the water pump is operating in a reduced-flow condition or no-flow condition. Transmitting 702, via a communication bus, a diagnostic alert to an outboard power control unit (PCU) if the water pump is operating in a reduced-flow condition or no-flow condition may be carried out by the microcontroller issuing a high-level fault code and packaging it with pertinent sensor data. Once the fault code is set, the microcontroller assembles a standardized CAN message containing the measured current, time stamps, and the identified error status. This message is then placed onto the internal CAN bus, where it is broadcast to all connected devices. Upon receiving the fault code, the outboard PCU logs the condition and can initiate any necessary corrective actions or operator alerts.

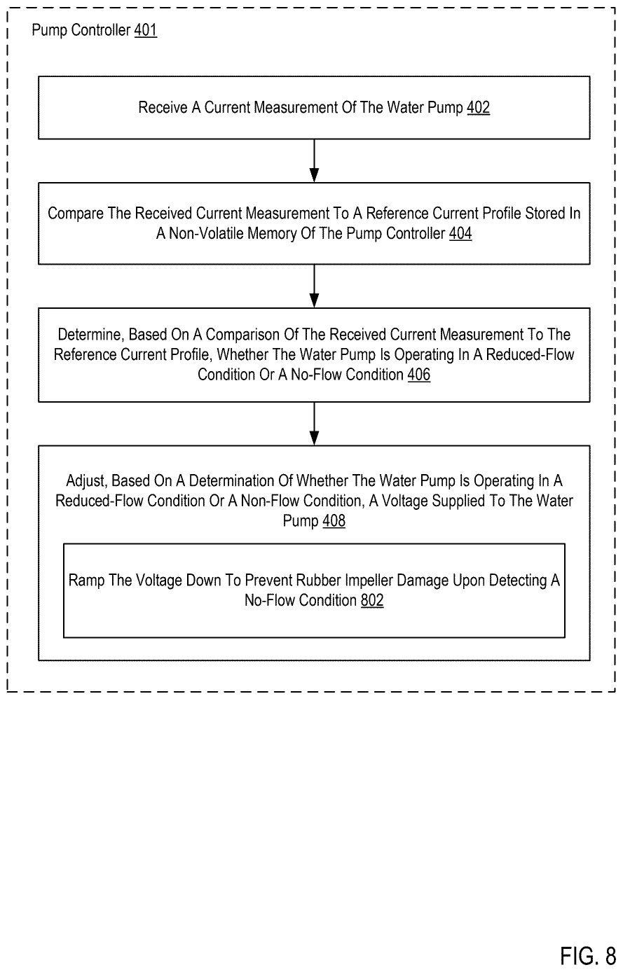

For further explanation, FIG. 8 sets forth a flow chart of another example method of adaptive control of a water pump in a marine propulsion system in accordance with at least one embodiment of the present disclosure. The method of FIG. 8 expands on the method of FIG. 4 in that the method of FIG. 8, adjusting 408, based on a determination of whether the water pump is operating in a reduced-flow condition or a non-flow condition, by the pump controller 401, a voltage supplied to the water pump includes ramping 802, by the pump controller 401, the voltage down to prevent rubber impeller damage upon detecting a no-flow condition. Ramping 802, by the pump controller 401, the voltage down to prevent rubber impeller damage upon detecting a no-flow condition may be carried out by continually comparing the measured current against a safe operating threshold. If the microcontroller identifies a persistent drop below this threshold, it progressively reduces the driver stage voltage from its current operating level to a lower, protective value. This controlled adjustment helps minimize frictional heat and mechanical stress on the impeller. Once the sensor interface reports current values returning to acceptable ranges, the controller gradually restores the voltage to a standard operating level.

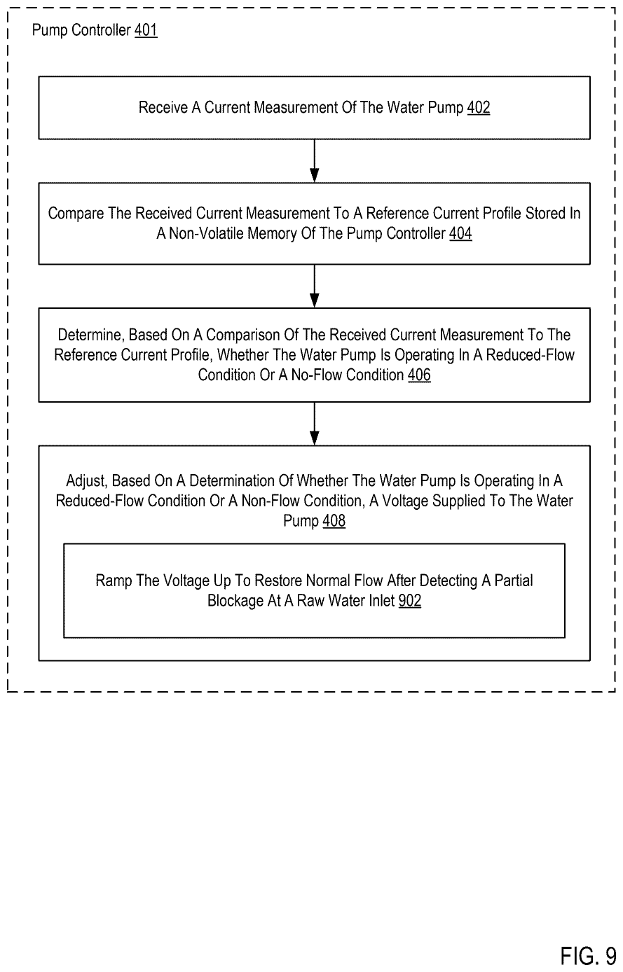

For further explanation, FIG. 9 sets forth a flow chart of another example method of adaptive control of a water pump in a marine propulsion system in accordance with at least one embodiment of the present disclosure. The method of FIG. 9 expands on the method of FIG. 4 in that the method of FIG. 9, adjusting 408, based on a determination of whether the water pump is operating in a reduced-flow condition or a non-flow condition, by the pump controller 401, a voltage supplied to the water pump includes ramping 902 the voltage up to restore normal flow after detecting a partial blockage at a raw water inlet. Ramping 902 the voltage up to restore normal flow after detecting a partial blockage at a raw water inlet may be carried out by incrementally increasing the driver stage output while continuously monitoring the pump's current draw. As the voltage rises, the increased pump speed helps dislodge debris or obstructions in the inlet path. Meanwhile, the microcontroller uses the sensor interface to check for a return to normal current levels. If normal current readings are attained, the controller logs the successful clearance event and stabilizes the voltage at an optimal operating setpoint.

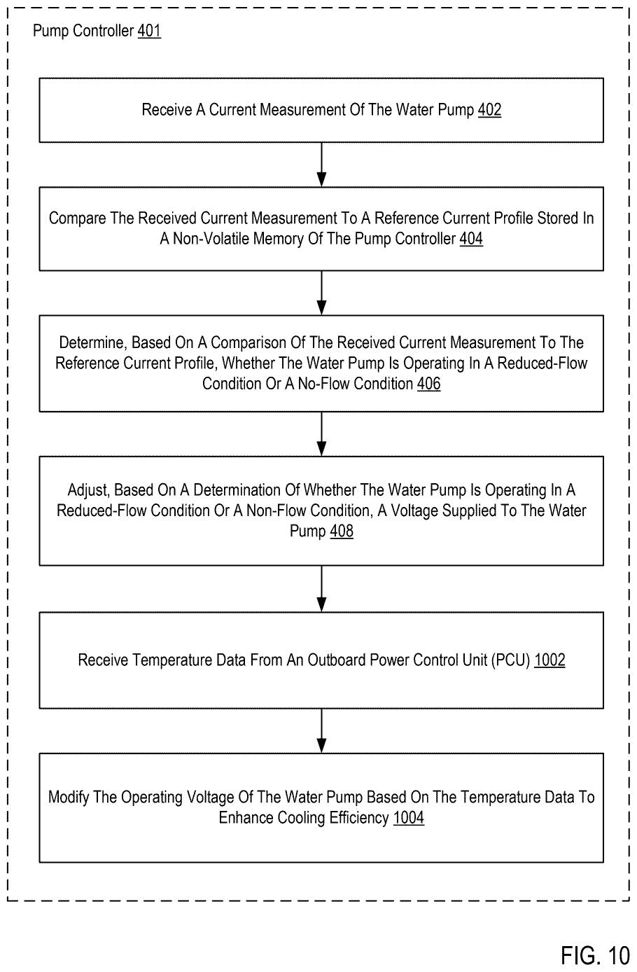

For further explanation, FIG. 10 sets forth a flow chart of another example method of adaptive control of a water pump in a marine propulsion system in accordance with at least one embodiment of the present disclosure. The method of FIG. 10 expands on the method of FIG. 5 by including receiving 1002, at the pump controller 401, temperature data from an outboard power control unit (PCU). Receiving 1002, at the pump controller 401, temperature data from an outboard power control unit (PCU) may be carried out by the microcontroller listening for temperature-related CAN frames on the internal CAN bus. Once the PCU broadcasts real-time temperature values under a specific CAN identifier, the pump controller parses these messages to extract the temperature data. The extracted data is then stored in a memory buffer for immediate use or future reference. If the temperature readings surpass predefined thresholds, the controller triggers corresponding actions, such as increasing pump voltage to improve cooling.

In addition, the method of FIG. 10 includes modifying 1004, by the pump controller 401, the operating voltage of the water pump based on the temperature data to enhance cooling efficiency. Modifying 1004, by the pump controller 401, the operating voltage of the water pump based on the temperature data to enhance cooling efficiency may be carried out by periodically reading temperature values from the outboard PCU and comparing them to predefined thresholds. If the detected temperature exceeds a critical level, the microcontroller increases the pump's supply voltage to boost coolant flow. This augmented flow accelerates heat dissipation and protects sensitive engine components. Once the temperature returns to a safe range, the microcontroller scales the voltage back down to conserve power.

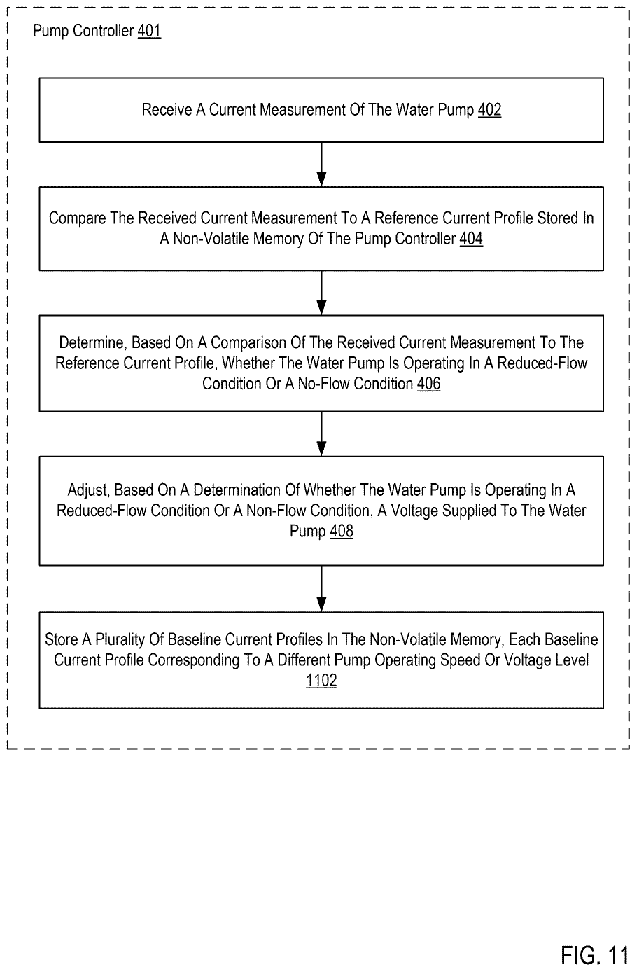

For further explanation, FIG. 11 sets forth a flow chart of another example method of adaptive control of a water pump in a marine propulsion system in accordance with at least one embodiment of the present disclosure. The method of FIG. 11 expands on the method of FIG. 5 by including storing 1102, by the pump controller 401, a plurality of baseline current profiles in the non-volatile memory. Each baseline current profile corresponds to a different pump operating speed or voltage level. Storing 1102, by the pump controller 401, a plurality of baseline current profiles in the non-volatile memory may be carried out by assigning each profile a unique index and writing it into flash memory or EEPROM during a calibration or setup procedure. Once written, these profiles can be referenced on-demand by the microcontroller for real-time comparisons. Each profile contains data points reflecting expected current ranges at various pump speeds or voltages. If an updated profile becomes necessary, the microcontroller overwrites the existing data in non-volatile memory to maintain accurate references.

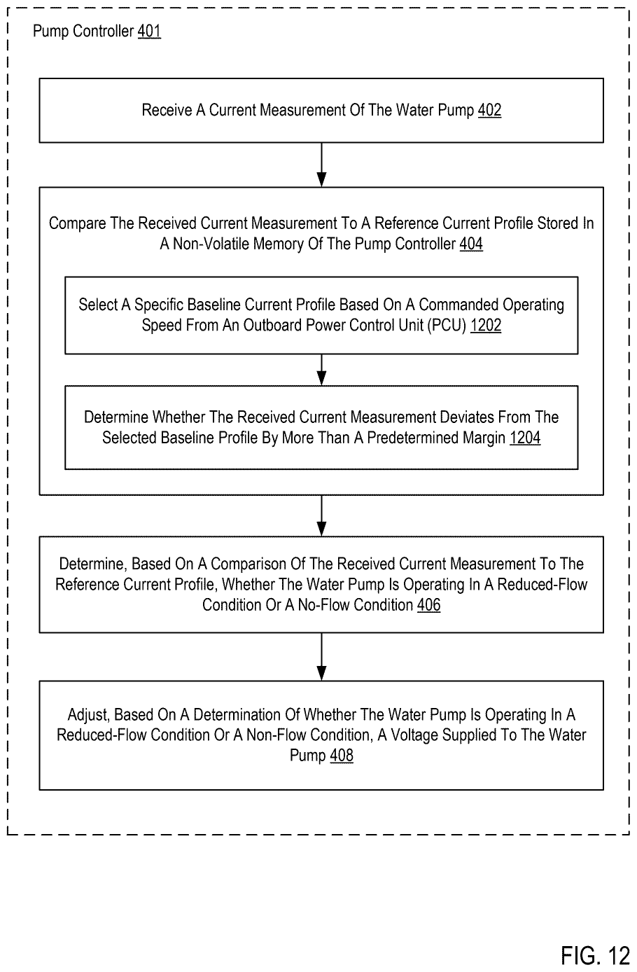

For further explanation, FIG. 12 sets forth a flow chart of another example method of adaptive control of a water pump in a marine propulsion system in accordance with at least one embodiment of the present disclosure. The method of FIG. 12 expands on the method of FIG. 4 in that the method of FIG. 12, comparing 404, by the pump controller 401, the received current measurement to a reference current profile stored in a non-volatile memory of the pump controller includes selecting 1202 a specific baseline current profile based on a commanded operating speed from an outboard power control unit (PCU). Selecting 1202 a specific baseline current profile based on a commanded operating speed from an outboard power control unit (PCU) may be carried out by reading the PCU's speed command from a dedicated CAN message and mapping it to a corresponding profile index. The pump controller then fetches the appropriate profile from non-volatile memory. This profile enumerates expected current ranges or characteristic curves for the specified pump speed. If the PCU later changes the speed command, the microcontroller repeats the mapping process to retrieve a different baseline profile.

In addition, comparing 404, by the pump controller 401, the received current measurement to a reference current profile also includes determining 1204 whether the received current measurement deviates from the selected baseline profile by more than a predetermined margin. Determining 1204 whether the received current measurement deviates from the selected baseline profile by more than a predetermined margin may be carried out by calculating the absolute difference between the measured current and the profile's expected value. If this difference exceeds the specified threshold, the microcontroller flags a potential anomaly. It then logs the discrepancy for diagnostic purposes and updates an internal status register. Depending on the severity, a control algorithm may reduce pump voltage or transmit a warning message to the outboard PCU.

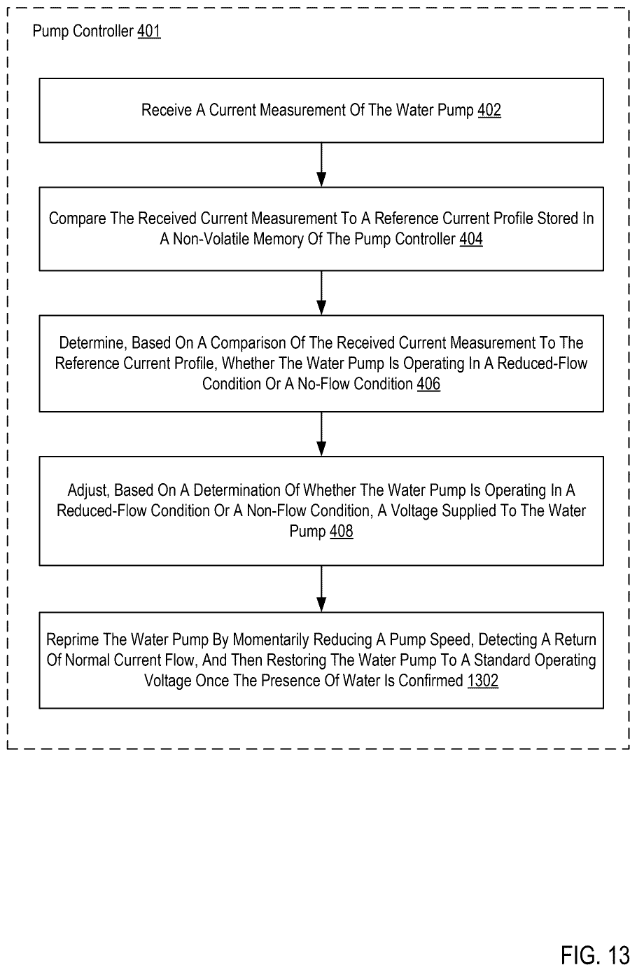

For further explanation, FIG. 13 sets forth a flow chart of another example method of adaptive control of a water pump in a marine propulsion system in accordance with at least one embodiment of the present disclosure. The method of FIG. 13 expands on the method of FIG. 5 by including repriming 1302, by the pump controller 401, the water pump by momentarily reducing a pump speed, detecting a return of normal current flow, and then restoring the water pump to a standard operating voltage once the presence of water is confirmed. Repriming 1302, by the pump controller 401, the water pump by momentarily reducing a pump speed, detecting a return of normal current flow, and then restoring the water pump to a standard operating voltage once the presence of water is confirmed may be carried out by first monitoring the current drawn by the pump to detect a no-flow condition. If this condition persists, the microcontroller temporarily reduces the driver stage voltage to minimize dry-running damage. During this lowered-voltage period, the sensor interface continuously checks for current values indicative of resumed water flow. Once normal or near-normal current readings are identified, the controller confirms that the impeller has regained prime. At that point, the microcontroller gradually ramps the voltage back to the standard operating level. Finally, the entire sequence is logged in non-volatile memory, and a status message may be dispatched to the outboard PCU through the CAN interface.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of adaptive control of a water pump in a marine propulsion system, the method comprising:
receiving, by a pump controller, a current measurement of the water pump;
comparing, by the pump controller, the received current measurement to a reference current profile stored in a non-volatile memory of the pump controller;
determining, based on a comparison of the received current measurement to the reference current profile, by the pump controller, whether the water pump is operating in a reduced-flow condition or a no-flow condition; and
adjusting, based on a determination of whether the water pump is operating in a reduced-flow condition or a non-flow condition, by the pump controller, a voltage supplied to the water pump.

2. The method of claim 1 wherein adjusting, based on the determination, by the pump controller, a voltage supplied to the water pump includes shutting down, by the pump controller, the water pump when the determination indicates the water pump is running dry, thereby preventing damage to an impeller.

3. The method of claim 1 further comprising logging, by the pump controller, in the non-volatile memory a fault event when the current measurement remains below a predetermined threshold for a set duration.

4. The method of claim 1 further comprising transmitting, by the pump controller, via a communication bus, a diagnostic alert to an outboard power control unit (PCU) if the water pump is operating in a reduced-flow or no-flow condition.

5. The method of claim 1 wherein adjusting the voltage supplied to the water pump comprises ramping, by the pump controller, the voltage down to prevent rubber impeller damage upon detecting a no-flow condition.

6. The method of claim 1 wherein adjusting the voltage supplied to the water pump comprises ramping, by the pump controller, the voltage up to restore normal flow after detecting a partial blockage at a raw water inlet.

7. The method of claim 1 further comprising:
receiving, at the pump controller, temperature data from an outboard power control unit (PCU); and
modifying, by the pump controller, the operating voltage of the water pump based on the temperature data to enhance cooling efficiency.

8. The method of claim 1 further comprising storing, by the pump controller, a plurality of baseline current profiles in the non-volatile memory, each baseline current profile corresponding to a different pump operating speed or voltage level.

9. The method of claim 8, wherein comparing the received current measurement to the reference current profile comprises:
selecting a specific baseline current profile based on a commanded operating speed from an outboard power control unit (PCU); and
determining whether the received current measurement deviates from the selected baseline profile by more than a predetermined margin.

10. The method of claim 1, further comprising repriming, by the pump controller, the water pump by momentarily reducing a pump speed, detecting a return of normal current flow, and then restoring the water pump to a standard operating voltage once the presence of water is confirmed.

11. An apparatus for adaptive control of a water pump in a marine propulsion system, the apparatus comprising:
a microcontroller configured to:
receive a measurement signal indicative of current drawn by the water pump;
compare the measurement signal to a reference current profile stored in a memory;
determine, based on a comparison of the received current measurement signal to the reference current profile, whether the water pump is operating in a reduced-flow condition or no-flow condition; and
generate a control signal responsive to said determination of whether the water pump is operating in a reduced-flow condition or a non-flow condition;
a sensor interface coupled to the microcontroller, the sensor interface configured to measure the current drawn by the water pump and provide the measurement signal to the microcontroller;
a driver stage configured to receive the control signal from the microcontroller and adjust a voltage applied to the water pump in accordance with the control signal; and
a communication interface configured to exchange data with an outboard power control unit (PCU).

12. The apparatus of claim 11, wherein the microcontroller is further configured to shut down the water pump automatically when the measurement signal indicates a no-flow condition exceeding a predetermined time threshold.

13. The apparatus of claim 11, wherein the memory stores multiple reference current profiles, each corresponding to a different pump operating speed; and the microcontroller is configured to select one of the stored reference current profiles based on a commanded operating speed received from the outboard PCU.

14. The apparatus of claim 11, wherein the microcontroller is further configured to log a fault event in the memory upon detecting that the current measurement deviates from the reference current profile by at least a predetermined margin for a specified duration.

15. The apparatus of claim 11, wherein the communication interface is configured to transmit a diagnostic alert to the outboard PCU upon detecting the reduced-flow/no-flow condition.

16. The apparatus of claim 11, wherein the microcontroller is further configured to reprime the water pump by reducing an operational voltage level, detecting a return of adequate current flow, and restoring the voltage to a normal operating level.

17. The apparatus of claim 11, wherein the microcontroller is configured to receive temperature data from the outboard PCU and adjust the voltage applied to the water pump based on the temperature data to increase cooling flow when high temperatures are detected.

18. The apparatus of claim 11, wherein the sensor interface includes an analog-to-digital converter configured to sample the electrical current at set intervals and send the resulting digital signal to the microcontroller for flow condition analysis.

19. The apparatus of claim 11, further comprising a protective enclosure housing at least the microcontroller and the sensor interface, the enclosure being configured to shield said components from moisture, vibration, and temperature extremes in a marine environment.

20. The apparatus of claim 11, wherein the microcontroller is further configured to modify the pump's operational speed in response to commands from the outboard PCU in order to optimize energy consumption during low-load operation while maintaining sufficient cooling for the system's components.
